(19) United States
(12) Patent Application Publication
(10) Pub. No.: US 2015/0332570 A1
(43) Pub. Date: Nov. 19, 2015

(54) RFID TAG OBJECT ASSOCIATION LOCATION SYSTEM

(71) Applicant: Senitron Corp., Beverly Hills, CA (US)

(72) Inventors: Leonard Nelson, Beverly Hills, CA (US); Michael McCoy, Beverly Hills, CA (US)

(21) Appl. No.: 14/712,531

(22) Filed: May 14, 2015

Related U.S. Application Data
(60) Provisional application No. 61/993,106, filed on May 14, 2014.

(51) Int. Cl. G08B 13/24

(52) U.S. Cl. CPC G08B 13/2462

(57) ABSTRACT

A RFID tag object association location system without reference to spatial location information using the RFID tag field. The system comprises RFID tags comprising extended object information associated with an object and secured to the object. One or more than one RFID reader having a resolution to differentiate between RFID tags that are close to each other and tags that are far away from each other communicatively coupled to the one or more than one RFID tag. Instructions executable on a processor communicatively coupled to the one or more than one RFID reader for data analysis of the extended object information, reporting useful information about the object stored on the RFID tag, determining an object fingerprint and performing relative object location comparison of the object fingerprints to determine a location for the object.

### CROSS-REFERENCE TO RELATED APPLICATIONS

This application claims the benefit under 35 U.S.C. §119(e) of U.S. Provisional Patent Application Ser. No. 61/993,106, filed on May 14, 2014, the contents of which are incorporated herein by reference in their entirety.

### FIELD OF THE INVENTION

The present invention relates to the field of radio frequency identification (RFID) and more specifically to an RFID tag object association location system using the RFID tag field to provide useful information without reference the physical location of infrastructure.

### BACKGROUND

Real Time Location Systems (RTLS) with RFID has been around for over twenty years, and work has continued on how to communicate the data from the RTLS since then. These RFID solutions can be broken down into handheld (mobile) solutions and “hands-free” infrastructure solution (fixed). Fixed infrastructure solutions have long been able to provide locations of RFID tags through a reference to the locations to the fixed infrastructure devices. In simple terms, one can “triangulate” between multiple antennas to find an approximate location, which can be delivered in X-Y terms, or X-Y-Z terms (including a height dimension). Many additional methods in addition to “triangulation” exist for ascertaining locations of passive, semi-passive, and active RFID tags and other wireless devices. These solutions provide location in reference to the fixed infrastructure locations.

Typically, identification of an objects location is an intermediate step to providing useful information that has business value, as shown in FIG. 1.

Currently, items in a retail store or any tagged RFID environment can be out of place or be in place. Information based on RFID implementations typically provide either 1) X-Y-Z coordinates or 2) more coarse “zones” with less granularity for item locations. RFID systems utilizing X-Y-Z measures (i.e. spatial map coordinates of items) are difficult for personnel to interpret, and require complex X-Y-Z mapping of “reference states” require configuration and maintenance of “reference states.” The process of triggering user alerts and actions requires the comparison of reference states to “actual states,” as measured by the RFID system, in order to trigger and alert users to action. Reference states correspond to “idealized” conditions that often require detailed configuration information, such as store models or known 3D models of physical environments and exact antenna locations. Actual states correspond to the true state of the dynamic, real-world physical environment. Unless the reference state is maintained at all times with high fidelity, differences between the reference state and actual state may no longer provide useful information about reality.

Also, personnel don't always understand or know their “reference state” to a high degree of fidelity to enable locating a desired object. If the physical environment changes, such as a remodel, or realignment of inventory, then the software configuration must be manually changed and a new “ideal state” configured. Many RTLS users find the X-Y-Z maps confusing and the software configuration is cumbersome. Plus, if the physical environment changes, such as a store remodel, or realignment of inventory, then the software configuration has to be manually changed and a new “ideal state” configured. Furthermore, the use of X-Y-Z coordinates by users in many physical environments requires training and interpretation of a new spatial coordinate schema that may differ from the way they currently communicate and interpret location information.

The identification of location coordinates of tags in relation to fixed infrastructure locations and comparison of the coordinates with business rules can be trivial for a laboratory-based or small-scale experiment, but become cumbersome in large-scale, dynamic environments. For example, a simple retail RFID implementation where two classes of items exist: men's clothing and women's clothing. The retailer provides a business rule that all items are to remain stocked in the appropriate section for the item's category, and that alerts should be triggered if items are misplaced, such as a men's item located in the women's section. A typical RFID implementation would the physical locations of the fixed antennas in the store to provide the relative locations of construct of the locations where the men's and women's items would be created derived from X-Y or X-Y-Z coordinates, forming the reference state. If the tagged items appear to be outside of their appropriate reference zone, then they are assumed to be “out-of-place” and a business alert is triggered. Such an alert is difficult to implement on a large scale because of 1) the large amount of labor required to set up and calibrate reference spatial locations based on known fixed antenna locations, 2) difficulty in mapping the exact boundaries between sections, and 3) the dynamic nature of merchandise which may be moved in response to changes in consumer trends, seasons, or company strategy.

Therefore, there is a need for an RFID tag object association location system using the RFID tag field itself to provide useful information without a requirement to reference the physical location of infrastructure or X-Y-Z spatial coordinate information.

### BRIEF DESCRIPTION OF THE DRAWINGS

These and other features, aspects and advantages of the present invention will become better understood with regard to the following description, appended claims, and accompanying figures where:

FIG. 1 is a prior art flowchart diagram of an RFID real time location system;

FIG. 2 is a flowchart diagram of an RFID tag object association location system using the RFID tag field to provide useful information without reference the physical location of infrastructure, according to one embodiment;

FIG. 3 is a work flow diagram of the RFID tag object association location system of FIG. 2;

FIG. 4 is an example report provided by the RFID tag object association location system of FIG. 2; and

FIG. 5 is a flowchart diagram of some steps of a method for using the RFID tag object association location system.

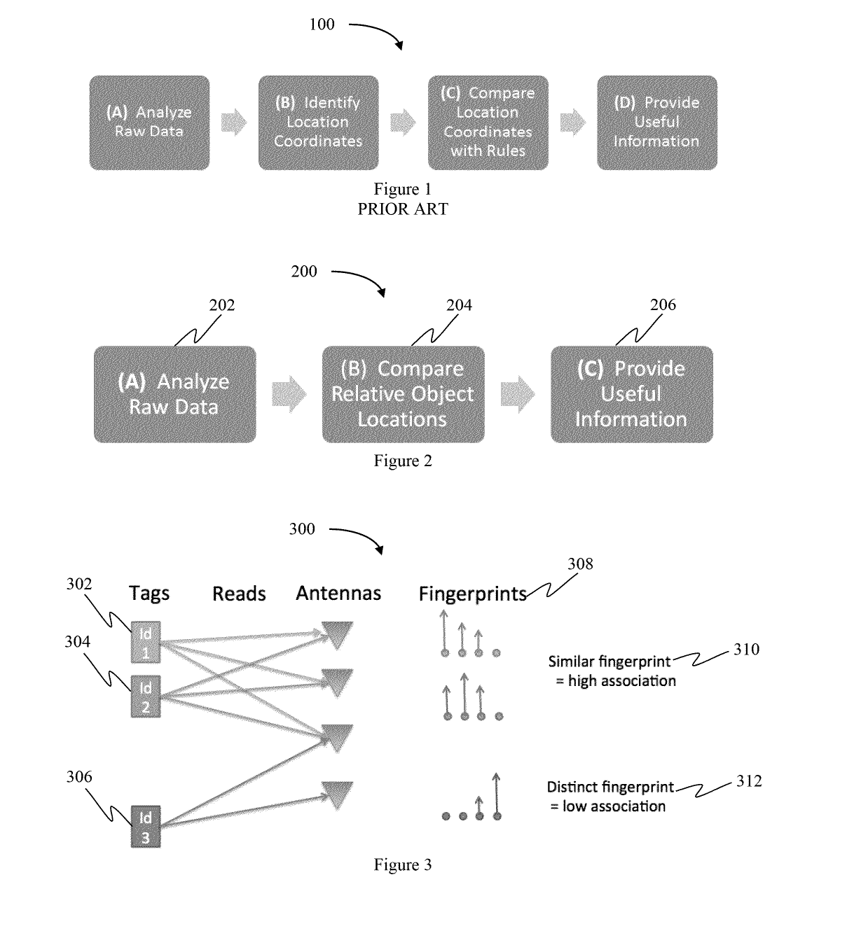

### SUMMARY

The present invention overcomes the limitations of the prior art by providing a RFID tag object association location system without reference to spatial location information using the RFID tag field. The system comprises one or more than one RFID tag comprising extended object information associated with an object and secured to the object, one or more than one RFID reader having a resolution to differentiate between RFID tags that are close to each other and tags that are far away from each other communicatively coupled to the one or more than one RFID tag. The extended object information comprises at least a SKU, an item number, a style, a category, a subcategory, and a family.

The system also has instructions executable on a processor communicatively coupled to the one or more than one RFID reader. The instruction are for 1) data analysis of the extended object information; 2) reporting useful information about the object stored on the RFID tag; 3) determining one or more than one object fingerprint; and 4) relative object location comparison of the one or more than one object fingerprint to determine a location for the object. The system determines the number of items grouped near sibling items and items in the same category.

The fingerprint provides pseudo-distances, distance estimates, or both pseudo-distances and distance estimates which are mapped in relation to a space with approximate distances. The executable fingerprint instructions can cluster objects by the approximate distances to one another without physically mapping the X-Y-Z space of each object. The fingerprint can comprise signal intensity, rate of reads, and a number of reads in a time period to identify the objects' location. The fingerprint also comprises relative intensities of RFID tag reads at each antenna.

The report created for the object is in easily understood natural language. The report created for the object identifies and provides a location of misplaced item using object associations in the space without spatial coordinates. The reports also provides a business action to be taken.

There is also provided a method for using a RFID tag object association location system without reference to spatial location information using the RFID tag field.

The method comprises the steps of first reading all the tags in a location. Then, generating a list of tag fingerprints that are stored in a storage. Next, grouping all the tags by features. Then, generating a fingerprint for each feature that summarizes all the tags that are stored in the storage. Next, determining a similarity value for each tag for all the features using a correlation, where a high-correlation implies high similarity. Finally, determining an objects location by the similarity value. The method also comprising the steps of: a) combining the stored tag fingerprint with an inventory database; and b) comparing each tag's fingerprints with fingerprints from the same fingerprints from each different style and printing a report. The method also further comprises storing RFID antenna locations in relation to the object as part of the fingerprint. The features comprises an individual identifier, of a tuple that combines a plurality of individual features.

Grouping the tags is accomplished using a clustering algorithm so that there are no features input beforehand. The objects location can be determined using at least two different thresholds to make a reliable determination of an object's location. The grouping uses a hierarchical indexing, so that all the RFID tag information can be extracted quickly and easily for a given feature. The fingerprints correspond to a particular inventory-derived feature.

### DETAILED DESCRIPTION

The present invention overcomes the limitations of the prior art by providing an RFID tag object association location system using the RFID tag field itself to provide useful information without X-Y-Z location information overcoming the limitations of the prior art. Additionally, the system can be used without a requirement to reference the spatial locations of fixed infrastructure nodes. Revisiting the previous example, the system uses a “nearest neighbor” approach between items to automatically identify the women's section and men's section of the retail store. Thus, if the zone boundaries were to change, the system would still be able to identify items within and outside the zone boundary without a manual reconfiguration of the system.

The object association model utilizes information associated with RFID tags, such as the SKU, item number, style, category, subcategory, family, etc., to “self-organize” RFID information and provide meaningful results. For example, with no knowledge of the spatial characteristics of a retail store, the system can describe the level of “cleanliness” and identify out-of-place items. The system accomplishes this by determining how many items are grouped near sibling items and items in the same category/subcategory, etc.

The system has the following technical advantages:
Lower software setup costs
Lower software maintenance costs
Lower relational database complexity
No need to have physical maps
Self-configuring: No need to have installers set up (because no “reference state” is necessary)
Technically flexible: The fingerprints can contain any type of data the reader puts out, including the read “rate”, the received signal strength, and phase information.

The system also has the following business advantages:
Lower system total cost of ownership
More rapid and lower cost deployment of software per location
More actionable insight into tagged items

The system uses fingerprints that provide “pseudo-distances” or “distance estimates” and then maps the store with approximate distances. The fingerprints can cluster items by their relative “approximate distances” to one another or any metric that encodes similarity and also encodes distance in some way. This is accomplished without physically mapping the X-Y-Z space of each object. This allows the system to report where an item is located in a language that human personnel can easily understand.

The system has been tested and can identify and provide a location of misplaced item using object associations in a retail environment. However, it is understood that this is by way of example only and that other implementations of the system can be performed in other locations within the scope of the claimed invention. For example, if a blue “crew neck” tee shirt can be identified by the system as being misplaced next to “v-neck” tee shirts because the RFID tag fingerprint of the “crew neck” has higher similarity (i.e., lower pseudo-distance) to the “v-neck” tee shirt T-shirts than the other crew neck items. Without reference to spatial location, the system is able to prompt a business action to be taken to clean the retail floor by replacing the item to its appropriate location.

To put it simply, the system wirelessly detects item locations for customers. Without providing a map of items locations. This prevents confusion, because there is no map to read or any distance and direction information. It also reduces the amount of work normally required to create these maps.

For example, most people describe the location of physical objects in relation to other objects:

Q: Have you seen the stapler?

A: Oh, yes, I left it over by the copy machine.

So, the system also can describe objects by their location in relation to other objects, without using mapping language to describe the location. For example, it would be much harder to find the stapler if its location was provided in X-Y terms: “45 feet southwest in quadrant G6 of the west wing.”

The system uses RFID tag object association location to answer in real life: “The stapler is located by the copy machine.”

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

Various embodiments provide an RFID tag object association location system using the RFID tag field itself to provide useful information without reference the physical location of infrastructure. In another embodiment, there is provided a method for using the system. The system and method will now be disclosed in detail.

Referring now to FIG. 2, there is shown a flowchart diagram of an RFID tag object association location system 200 using the RFID tag field to provide useful information without reference the physical location of infrastructure, according to one embodiment. As can be seen, the RFID tag object association location system 200 eliminates the requirement for comparing coordinates, as is presently used in RTLS systems, by comparing relative object locations 204. The RFID tag object association location system 200 provides useful information 206 without reference to X-Y-Z location information and without a requirement to reference the spatial locations of fixed infrastructure nodes. The RFID tag object association location system 200 uses a “nearest neighbor” approach between items to automatically identify the object's location in the store or other area. The RFID tag object association location system 200 also can provide this information even if the zone boundaries were to change. The RFID tag object association location system 200 will still be able to identify objects within and outside the zone boundary without a manual reconfiguration of the system or providing new store mappings or zones.

Referring now to FIG. 3, there is shown a workflow diagram 300 of the RFID tag object association location system 200. Without determining X-Y-Z coordinates, we can still readily determine the relative location of objects 204 by comparing the statistics collected by the readers from the tags 302, 304, 306. For example, we may collect the relative intensities of each tag 302-306 read at each antenna to generate a “fingerprint” 308 that we can compare between antennas 302-306. Similar fingerprints 310 indicate that the tags are close to one another, while different fingerprints 312 suggest that tags are far apart.

It is essential that the RFID tag object association location system 200 comprise instructions operable on a processor to identify and determine characteristics of each tag 302-306, in a resolution that allows the system 200 to differentiate between tags that are close to each other and tags that are far away from each other. Physical location of the fixed infrastructure (antenna locations) and other X-Y spatial data can be included to enrich the information collected by the system, but is not required to provide utility to the user.

As can be seen, each of the RFID tags 302-306 comprise information about the object that is read by RFID antennas located throughout the space. The system 200 compares the information read from the RFID tags 302-306 and determines a fingerprint 308 for each RFID tag 302-306. Then, the fingerprints 308 are compared to other objects located near a particular object. If the surrounding RFID tag 302-306 fingerprints 308 are similar to the other RFID tags 302-306 surrounding the object, then the system 200 determines that there is a high association 310 threshold and that the object is in its proper location. However, if an object's RFID tag 302-306 fingerprint 308 is distinct from the other objects in the vicinity, then the system 200 determines that the fingerprint 308 is distinct and that the object is not in the proper location.

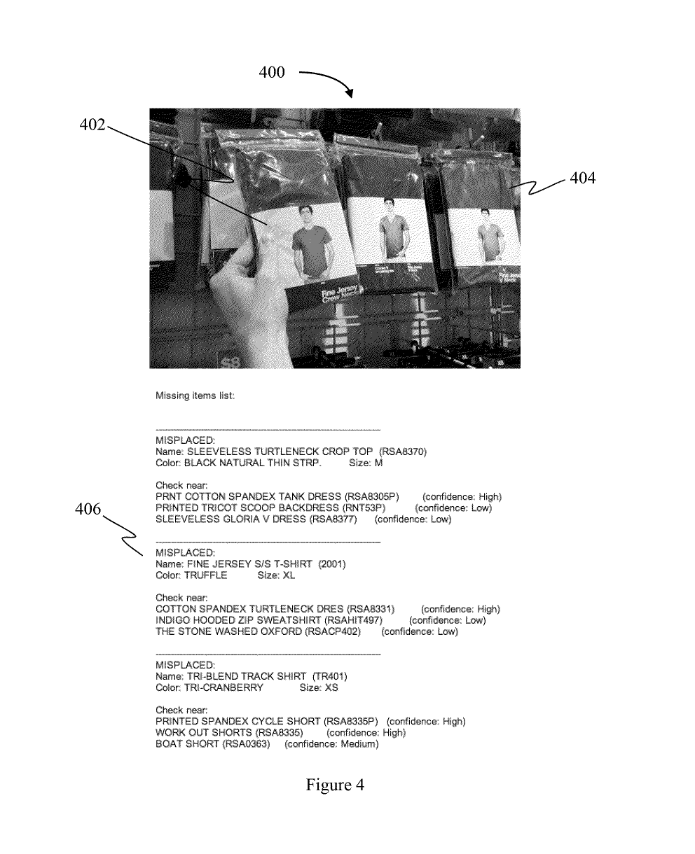

Referring now to FIG. 4, there is shown an example report 400 provided by the RFID tag object association location system 200. As can be seen, the object in this example is a crew neck tee T-shirt 402. The crew neck tee T-shirt 402 is misplaced because the fingerprints 308 of the objects nearby are for vee neck tee T-shirts 404. The report 406 shows the name of the object, and the information associated with the RFID tag 302-306 on the package. Additionally, information is given where to locate the item because of the surrounding fingerprints 308. In this case, the crew neck tee T-shirt 402 was located near a cotton spandex turtle neck dress, an indigo hooded zip sweatshirt and stone washed oxfords. This report 406 makes it easy for store personnel to locate the item and return it to its proper space in the store quickly and efficiently.

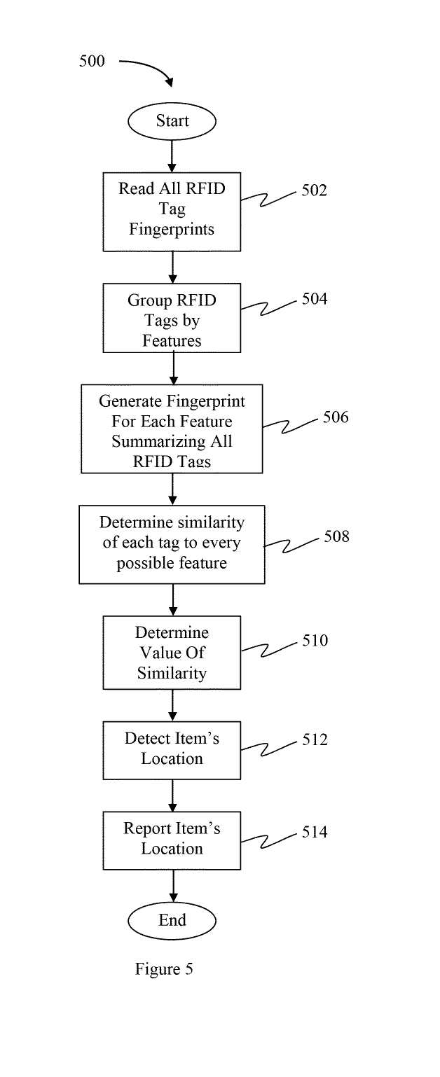

Referring now to FIG. 5, there is shown a flowchart diagram 500 of some steps of a method for using the RFID tag object association location system 200. First, the system reads 502 all the tags in a location and generates list of tag fingerprints that are stored in a storage. Although many fingerprints are possible, the system preferably includes signal intensity, or rate of reads, number of reads in the last 10 minutes, or any combination of the above, in the fingerprint to better help identify the objects location at a later time.

Optionally, antenna locations in relation to the object can also be stored as part of the fingerprint. Then, all the tags are grouped by features 504. Features can be individual feature, such as, for example, a department (“men's”), a style (“socks”) or a tuple (“men's”, “socks”) that combines a plurality of individual features. The features will vary from object to object and from location to location. Additionally, the system can also group tags using a clustering algorithm (e.g., k-means) so that there are no features input into the system beforehand. This is dependent upon the situation and user requirements for the inventory. Next, a fingerprint is generated 506 for each feature that summarizes all the tags, and stored in a storage. For example, an average value of the antenna reads over the group can be used to summarize all the tags. As can be appreciated, other summary functions are possible, such as, for example, medians instead of averages. Then, a similarity value 508 for each tag is determined for all the features (e.g., how much “socks” look like “shorts”). As will be understood by those with skill in the art with reference to this disclosure, there are innumerable similarity functions.

Preferably, the system uses correlation, where a high-correlation implies high similarity. The system can determine where tags are located 512 relative to other styles by the value of the similarity function. In a preferred embodiment, the system can use at least two different thresholds to make a reliable “close/far” determination of an object's location. Optionally, the system can use a variant of the above to detect misplaced items. Next, the tags are grouped.

Preferably, the grouping uses a hierarchical indexing, so that all the tag information can be extracted quickly and easily for a given style, department or other feature. For example, the system can use the stored tag data to quickly identify a subset of the stored tag data based on one or more than on feature, such as, for example, “sort by style” or “list all leopard-print shorts.” In a preferred embodiment, the tag fingerprints are stored in a hash table combined with style information to produce the hierarchical indexes. Alternatively, the fingerprints can correspond to a particular inventory-derived features (e.g., style, size, or even price). Also, the relationship between features stored in the fingerprint can be implemented using graph structures, linked lists, linear arrays, or other data structures currently known or unknown.

Finally, the system combines the stored tag fingerprint with an inventory database, and groups the tags according to the inventory information (e.g., by style) and then compares the each tag's fingerprints with fingerprints from the same “style” and fingerprints from each different style and prints a report 514 of “misplaced” or out of place items. Optionally, the system can be configured to compare tag fingerprints to one another before incorporating style information. In this case, tags that are expected to be nearby but that have “anomalous” styles are identified as outliers.

What has been described is a new and improved system and method for an RFID tag object association location system using the RFID tag field to provide useful information without reference the physical location of infrastructure, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A RFID tag object association location system without reference to spatial location information using the RFID tag field, the system comprising:
a) one or more than one RFID tag comprising extended object information associated with an object and secured to the object;
b) one or more than one RFID reader having a resolution to differentiate between RFID tags that are close to each other and tags that are far away from each other communicatively coupled to the one or more than one RFID tag; and
c) instructions executable on a processor communicatively coupled to the one or more than one RFID reader for:
1) data analysis of the extended object information;
2) reporting useful information about the object stored on the RFID tag;
3) determining one or more than one object fingerprint; and
4) relative object location comparison of the one or more than one object fingerprint to determine a location for the object.

2. The system of claim 1, where the extended object information comprises at least a SKU, an item number, a style, a category, a subcategory, and a family.

3. The system of claim 1, where the instructions executable on the processor determine the number of objects grouped near sibling items and items in the same category.

4. The system of claim 1, where the one or more than one fingerprint provides pseudo-distances, distance estimates, or both pseudo-distances and distance estimates which are mapped in relation to a space with approximate distances.

5. The system of claim 4, where the executable fingerprint instructions can cluster items by the approximate distances to one another without physically mapping the X-Y-Z space of each object.

6. The system of claim 1, where the one or more than one object fingerprint comprises signal intensity, rate of reads, and a number of reads in the a time period to identify the objects' location.

7. The system of claim 1, the fingerprint comprises relative intensities of RFID tag reads at each antenna.

8. The system of claim 1, where the report created for the object is in easily understood natural language.

9. The system of claim 1, where the report created of the object identifies and provides a location of misplaced item using object associations in the space without spatial coordinates.

10. The system of claim 9, where, without reference to spatial location, the system reports a business action to be taken.

11. A method for using a RFID tag object association location system without reference to spatial location information using the RFID tag field, the method comprising the steps of:
a) providing the system of claim 1;
b) reading all the tags in a location;
c) generating a list of tag fingerprints that are stored in a storage;
d) grouping all the tags by features;
e) generating a fingerprint for each feature that summarizes all the tags that are stored in the storage;
f) determining a similarity value for each tag for all the features using a correlation, where a high-correlation implies high similarity; and
g) determining an objects location by the similarity value.

12. The method of claim 11, further comprising the steps of:
a) combining the stored tag fingerprint with an inventory database; and
b) comparing each tag's fingerprints with fingerprints from the same fingerprints from each different style and printing a report.

13. The method of claim 11, further comprises the step of storing RFID antenna locations in relation to the object as part of the fingerprint.

14. The method of claim 11, where the features comprises an individual identifier.

15. The method of claim 11, where the features comprises a tuple that combines a plurality of individual features.

16. The method of claim 11, where the step of grouping tags is accomplished using a clustering algorithm so that there are no features input beforehand.

17. The method of claim 11, where the grouping uses a hierarchical indexing, so that all the RFID tag information can be extracted quickly and easily for a given feature.

18. The method of claim 11, where the objects location can be determined using at least two different thresholds to make a reliable determination of an object's location.

19. The method of claim 11, where the fingerprints correspond to a particular inventory-derived feature.
